(19) United States
(12) Patent Application Publication
(10) Pub. No.: US 2010/0307699 A1
(43) Pub. Date: Dec. 9, 2010

(54) WINDOW BLIND AND RELEASE BRACKET THEREOF

(76) Inventor: KUEI-TING CHEN, Tainan Hsien (TW)

Correspondence Address: Hershkovitz & Associates, LLC, 2845 Duke Street, Alexandria, VA, 22314, US

(21) Appl. No.: 12/481,565

(22) Filed: Jun. 9, 2009

(51) Int. Cl. E06B 9/38; E06B 9/24

(52) U.S. Cl. 160/127; 160/173 R

(57) ABSTRACT

A window blind has a rail, a shade, multiple guide rings, multiple release brackets and multiple cords. The shade is connected to the rail and has a bottom slat and multiple intermediate slats. The guide rings are mounted on the shade between two adjacent intermediate slats. The release brackets are mounted on the bottom slat and each has a release mount and a resilient clip. The release mounts are attached to the bottom slat and a corresponding resilient clip is detachably mounted in the release mount. The cords are mounted through the rail and each cord passes through corresponding guide rings and connects to the resilient clip of a corresponding release bracket. The release bracket separates above a predetermined force so reduces a choking hazard to pets and children and prevents damage to blinds caused by high winds or incorrect operation.

### BACKGROUND OF THE INVENTION

1. Field of the Invention

The invention relates to a window blind, especially to a window blind having release brackets to protect against choking hazards.

2. Description of the Related Art

With reference to FIG. 5, a conventional window blind has a rail (60), a shade (70), multiple rings (80) and multiple cords (90).

The shade (70) is attached to the rail (60) by a top edge and has multiple horizontal slats (71) attached adjacently and parallelly together. The rings (80) are mounted between two adjacent slats (71). The cords (90) are mounted through the rail (60) and each cord (90) passes through corresponding rings (80) and is connected to a corresponding bottom-most ring (80). By pulling or releasing the cords (90), the shade (70) may be drawn or opened.

However, the cord (90) may accidentally wrap around the neck of children, animals or the like causing a choking hazard since the cords (90) are firmly connected to the bottom-most ring (80).

To overcome the shortcomings, the present invention provides a window blind and a release bracket thereof to mitigate or obviate the aforementioned problems.

### SUMMARY OF THE INVENTION

The main objective of the invention is to provide a window blind having release brackets to protect against choking hazards.

The window blind in accordance with the present invention has a rail, a shade, multiple guide rings, multiple release brackets and multiple cords.

The shade is connected to the rail and has a bottom slat and multiple intermediate slats. The guide rings are mounted between two adjacent intermediate slats. The release brackets are mounted on the bottom slat and each has a release mount and a resilient clip. The release mounts are attached to the bottom slat and corresponding resilient clip is detachably mounted in the release mount. The cords are mounted through the rail and each cord passes through corresponding guide rings and is connected to the resilient clip of a corresponding release bracket.

The release brackets stay connected up to a predetermined force sufficient to support the shade, cords and operation thereof, but further adding a certain force causes separation. Thus children or animals wrapped in a cord can escape with lowered choking risk.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a window blind having release brackets in accordance with the present invention;

FIG. 2 is an exploded perspective view of the release bracket in FIG. 1;

FIG. 3 is a side view of the window blind in FIG. 1, shown opened;

FIGS. 4a and 4b show automatic release of the release bracket in FIG. 2; and

FIG. 5 is a front view of a conventional window blind.

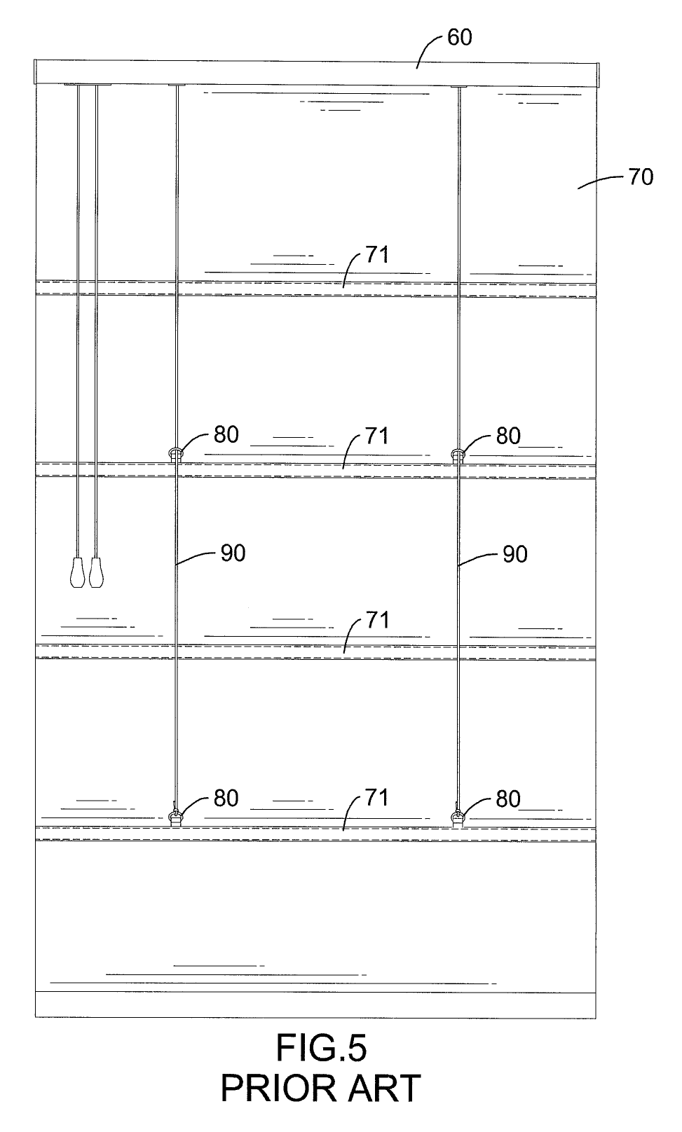

### DETAILED DESCRIPTION OF THE PREFERRED EMBODIMENTS

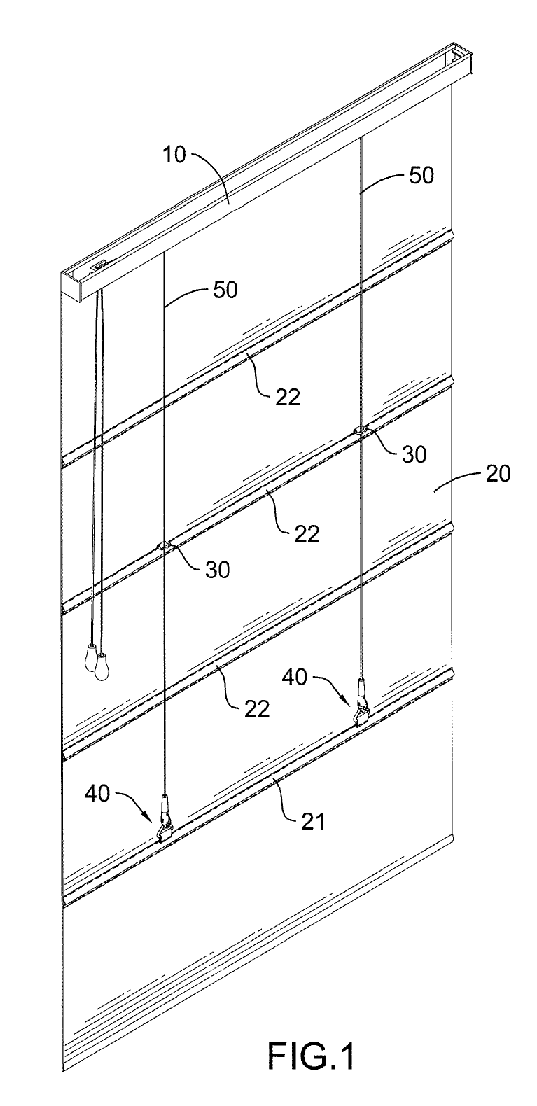

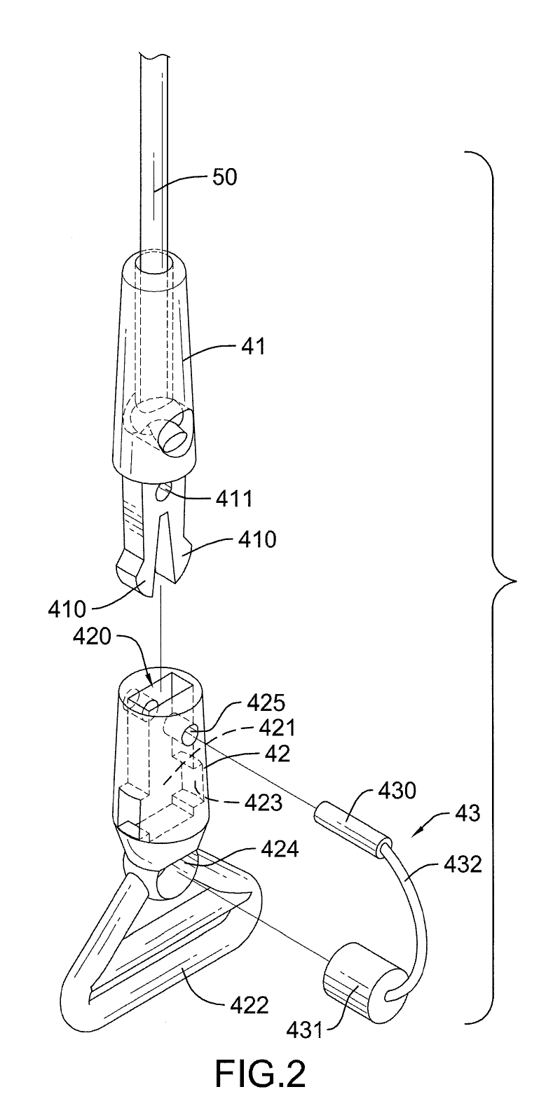

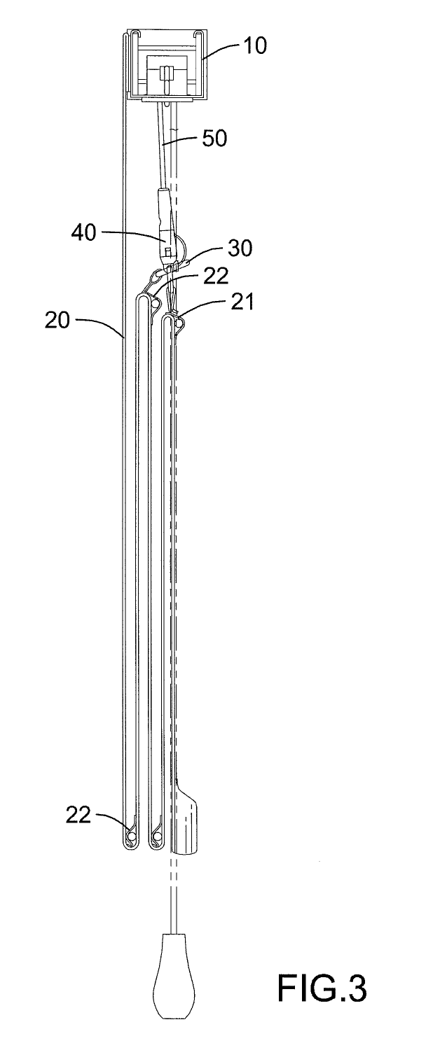

With reference to FIGS. 1 to 3, a window blind in accordance with the present invention comprises a rail (10), a shade (20), multiple guide rings (30), multiple release brackets (40) and multiple cords (50).

The rail (10) has a longitudinal edge.

The shade (20) is connected to the rail (10) and has a top edge, a bottom edge, a bottom slat (21) and multiple intermediate slats (22). The top edge of the shade (20) is attached to the longitudinal edge of the rail (10). The slats (21, 22) are parallelly and adjacently disposed, and may be wooden material or the like and may be defined by folds. The bottom slat (21) is disposed at the bottom edge of the shade (20). The intermediate slats (22) are disposed between the bottom slat (21) and the top edge of the shade (20).

The guide rings (30) are mounted on the shade (20) between two adjacent intermediate slats (22).

The release brackets (40) are mounted on the bottom slat (21) and each release bracket (40) has a release mount (42) and a resilient clip (41) and may have a bayonet device (43).

The release mount (42) is attached to the bottom slat (21) and has a bottom and may have a top opening (420) and a chamber (421). The bottom of the release mount (42) is attached to the bottom slat (21) and may be attached to the bottom slat (21) by a ring (422). The chamber (421) is formed in the release mount (42), communicates with the top opening (420) and has two opposite chamber walls and two inner recesses (423). The inner recesses (423) are respectively formed in the chamber walls maybe through the release mount (42). The release mount (42) may further has a mounting hole (424) that may be formed through the bottom of the release mount (42) and a through hole (425) formed through the release mount (42) and communicates with the chamber (421).

The resilient clips (41) are detachably mounted in corresponding release mounts (42), may be mounted in the chambers (421) of the release mounts (42) and each may have a proximal end and two tabs (410). The tabs (410) are formed on and protrude from the proximal end and are separated by a gap and may be respectively and detachably mounted in the inner recesses (423) of the release mount (42). Each resilient clip (41) may further have a through hole (411) formed through the resilient clip (41) and corresponding in shape and in position to a corresponding release mount (42) when the resilient clip (41) is mounted in the chamber (421) of the corresponding release mount (42).

The cords (50) are mounted through the rail (10) and each cord (50) passes through corresponding guide rings (30) and is connected to the resilient clip (41) of a corresponding release bracket (40). The shade (20) can be drawn or opened by pulling or releasing the cords (50).

Each bayonet device (43) has a bayonet body (430), a bolt (431) and a connecting cord (432). The bayonet body (430) is brittle and mounted through the through holes (411, 425) of a corresponding release bracket (40) when the resilient clip (41) and release mount (42) of said release bracket (40) are engaged with other. The bolt (431) is mounted in the mounting hole (424) of the release mount (42) of said release bracket (40). The connecting cord (432) connects the bayonet body (430) and the bolt (431).

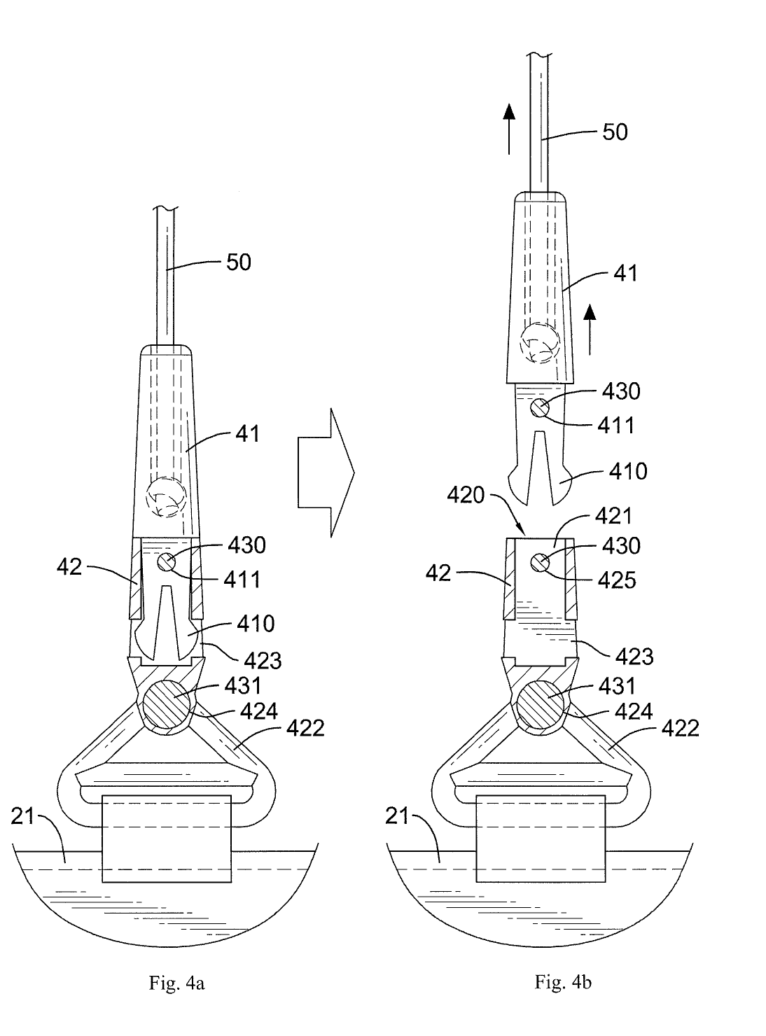

With further reference to FIG. 4a and FIG. 4b, should a child or animal accidentally get their neck stuck between the shade (20) and the cords (50), the resilient clip (41) and the release mount (42) of the release bracket (40) will separate due to increases force so exposing pets and children to reduced choking hazards. Further, the release bracket (40) prevents the window blind from being damaged by high winds, incorrect operation or the like. Besides, since the release brackets stay connected up to a sufficient to support the shade, cords and operation thereof, the brittle bayonet body (430) of the bayonet device (43) can moderately enhance the predetermined force.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A window blind comprising:
a rail having a longitudinal edge;
a shade connected to the rail and having
a top edge attached to the side edge of the rail;
a bottom edge; and
a bottom slat disposed at the bottom edge of the shade;
multiple intermediate slats disposed between the bottom slat and the top edge of the shade;
multiple guide rings mounted on the shade between two adjacent intermediate slats;
multiple release brackets mounted on the bottom slat and each release bracket having
a release mount attached to the bottom slat; and
a resilient clip detachably mounted in the release mount; and
multiple cords mounted through the rail and each cord passing through corresponding guide rings and connected to the resilient clip of a corresponding release bracket.

2. The window blind as claimed in claim 1, wherein
each release mount has
a bottom attached to the bottom slat;
a top opening; and
a chamber formed in the release mount, communicating with the top opening, and having
two opposite chamber walls; and
two inner recesses respectively formed in the chamber walls; and
each resilient clip has
a proximal end; and
two tabs formed on and protruding from the proximal end, separated by a gap and respectively and detachably mounted in the inner recesses of a corresponding release mount.

3. The window blind as claimed in claim 2, wherein the bottom of the release mount is attached to the bottom slat by a ring.

4. The window blind as claimed in claim 2, wherein
each release mount further has
a mounting hole formed through the bottom of the realse mount; and
a through hole formed through the release mount nad communicating with the chamber of the release mount;
each resilient clip further has a through hole formed through the resilient clip and corresponding in shape and in position to a corresponding release mount when the resilient clip is mounted in the chamber of the corresponding release mount; and
each release bracket further has a bayonet device having
a brittle bayonet body mounted through the through holes of a corresponding release bracket when the resilient clip and release mount of said release bracket are engaged with other;
a bolt mounted in the mounting hole of the release mount of said release bracket; and
a connecting cord connecting the bayonet body and the bolt.

5. A release bracket for a window blind comprising:
a release mount having
a bottom;
a top opening; and
a chamber formed in the release mount, communicating with the top opening, and having
two opposite chamber walls; and
two inner recesses respectively formed in the chamber walls; and
a resilient clip having
a proximal end; and
two tabs formed on and protruding from the proximal end,
separated by a gap and respectively and detachably mounted in the inner recesses of a corresponding release mount.

6. The release bracket as claimed in claim 5, wherein
each release mount further has
a mounting hole formed through the bottom of the realse mount; and
a through hole formed through the release mount nad communicating with the chamber of the release mount;
each resilient clip further has a through hole formed through the resilient clip and corresponding in shape and in position to a corresponding release mount when the resilient clip is mounted in the chamber of the corresponding release mount; and
each release bracket further has a bayonet device having
a brittle bayonet body mounted through the through holes of a corresponding release bracket when the resilient clip and release mount of said release bracket are engaged with other;
a bolt mounted in the mounting hole of the release mount of said release bracket; and
a connecting cord connecting the bayonet body and the bolt.
